(19) United States
(12) Patent Application Publication
(10) Pub. No.: US 2014/0283565 A1
(43) Pub. Date: Sep. 25, 2014

(54) Luggage Locking Apparatus and Method

(71) Applicant: Joseph Edwards, Port of Spain (TT)

(72) Inventor: Joseph Edwards, Port of Spain (TT)

(21) Appl. No.: 13/847,725

(22) Filed: Mar. 20, 2013

(51) Int. Cl. E05B 17/00

(52) U.S. Cl. CPC E05B 17/00
USPC 70/2

(57) ABSTRACT

The present invention is directed to a luggage security apparatus, and methods of using the same. The apparatus includes a flexible strap including a first end, a second end, a first connector and a second connector, wherein the first connector is positioned proximal to the first end and the second connector is positioned proximal to the second end; and an engagement structure positioned on the flexible strap between the first end and the second end. The first end is capable of being folded around the stationary handle of the luggage and the first connector removably engaged with the engagement structure, and the second end is capable of being folded around the telescopic handle of the luggage and the second connector removably engaged with the engagement structure.

### CROSS-REFERENCE TO RELATED APPLICATION

This application claims the benefit of U.S. design patent application No. 29/403,783, filed Oct. 11, 2011, which is incorporated by reference herein in its entirety.

### FIELD OF THE INVENTION

The present invention generally relates to the field of luggage security; more particularly, the present invention pertains to the field of luggage restraining devices and methods.

### BACKGROUND OF THE INVENTION

When one travels, they are often separated from their luggage. Airlines, in particular, have strict guidelines for the acceptable sizes allowed as carry-ons, so most travelers are faced with the necessity of checking their luggage and picking it up at the conclusion of their travels.

Modern day luggage includes wheels and generally also includes a telescoping handle that extends to allow a traveler to comfortably grasp the handle and walk with the luggage as it rolls behind them. This further allows travelers to increase the weight carried in a single piece of luggage since they do not need to physically carry the luggage to and from baggage claim and their home, hotel or car.

One of the drawbacks of utilizing larger and heavier bags that necessitates checking luggage at the airport is that one's bag is often left unattended, sometimes for several minutes, as the passenger makes their way to the baggage claim area. This period of time where one's bag is left unattended is a prime time for a thief to walk up to and roll the passenger's heavy roller luggage away to an unintended destination.

In light of this security concern, there is a need for a device that deters would-be thieves by preventing one from easily rolling luggage equipped with rollers and telescoping handles.

### SUMMARY OF THE INVENTION

In view of the foregoing background, it is therefore an object of the present invention to provide a security means for standard roller luggage bags that prevents ease of rolling the bag while walking. As such, the present invention is directed to a luggage security apparatus for placement on roller luggage bags containing a telescopic handle, in addition to methods of utilizing the same.

The luggage security apparatus includes a flexible strap with a first end, a second end, a first connector and a second connector. The first connector is positioned proximal to the first end and the second connector is positioned proximal to the second end. The apparatus additionally includes an engagement structure positioned on the flexible strap between the first end and the second end. The first end is capable of being folded around the stationary handle portion of the luggage bag and the first connector removably engaged with the engagement structure; likewise, the second end is capable of being folded around the telescopic handle portion of the luggage bag and the second connector removably engaged with the engagement structure. Generally, the engagement structure includes a loop-structure dimensioned for removable engagement by the first connector, the second connector and an additional locking means, such as, but not limited to, a key or combination lock or a mechanism built into the engagement structure. A locking mechanism may be removably attached to the engagement structure to lock the first connector and second connector to the engagement structure to prevent the telescopic handle from being withdrawn and utilized to roll the luggage.

The present invention is further directed to a method of securing the stationary and telescopic handles of luggage. The method includes placing the luggage security apparatus, as described herein, underneath the stationary and telescopic handles of the luggage; folding the first end around the stationary handle; engaging the first connector with the engagement structure; folding the second end around the telescopic handle; engaging the second connector with the engagement structure; and placing a locking mechanism onto the engagement structure to lock the first connector and second connector to the engagement structure.

These and other objects, aspects, and advantages of the present invention will be better appreciated in view of the drawings and the following detailed description of the embodiments.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a perspective view of a luggage security apparatus, according to an embodiment of the present invention;

FIG. 2 is a perspective view of the luggage security apparatus of FIG. 1 being utilized to secure the telescopic handle of luggage;

FIG. 3 illustrates an embodiment of a luggage security apparatus of the present invention including multiple reinforcement strips (dashed lines); and

FIG. 4 illustrates an embodiment of a luggage security apparatus of the present invention without a flexible member.

Like reference numerals refer to like parts throughout the several views of the drawings.

### DETAILED DESCRIPTION

In the Summary of the Invention, the Detailed Description and the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

The terminology used herein is for the purpose of describing particular embodiments only and is not intended to be limiting of the invention. As used herein, the indefinite articles “a”, “an” and “the” should be understood to include plural reference unless the context clearly indicates otherwise.

The phrase “and/or,” as used herein, should be understood to mean “either or both” of the elements so conjoined, i.e., elements that are conjunctively present in some cases and disjunctively present in other cases.

As used herein, “or” should be understood to have the same meaning as “and/or” as defined above. For example, when separating a listing of items, “and/or” or “or” shall be interpreted as being inclusive, i.e., the inclusion of at least one, but also including more than one, of a number of items, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

The term “comprises” is used herein to mean that other elements, steps, etc. are optionally present. When reference is made herein to a method comprising two or more defined steps, the steps can be carried out in any order, or simultaneously (except where the context excludes that possibility), and the method can include one or more steps which are carried out before any of the defined steps, between two of the defined steps, or after all of the defined steps (except where the context excludes that possibility).

As used herein, the terms “including”, “includes”, “having”, “has”, “with”, or variants thereof, are intended to be inclusive similar to the term “comprising.”

In this section, the present invention will be described more fully with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art.

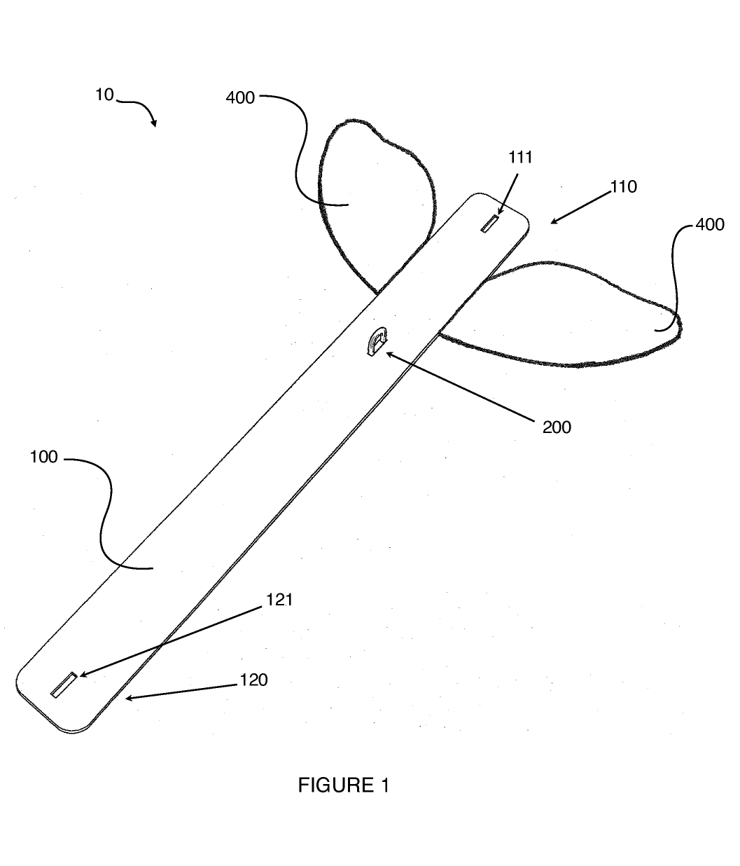

The present invention is directed to a luggage security apparatus to prevent extension of a telescopic handle and hinder ease of rolling the luggage. The luggage security apparatus is utilized for roller-type luggage that includes stationary handles in addition to telescopic handles for extending such that a user can easily roll the luggage. As illustrated in the accompanying drawings, and with primary reference to FIG. 1, a luggage security apparatus is shown, generally indicated as 10. The apparatus 10 includes a flexible strap 100 having a first end 110, with corresponding first connector 111 positioned proximal thereto, and a second end 120, with corresponding second connector 121 positioned proximal thereto. The apparatus further includes an engagement structure 200 positioned on the flexible strap 100 between the first end 110 and the second end 120. The apparatus 10 may also include at least one flexible member 400 extending from the flexible strap 100 proximal to the first end 110 and/or second end 120. The flexible member 400 functions to at least partially obstruct one or more of the handles on the luggage when the apparatus 10 is in place.

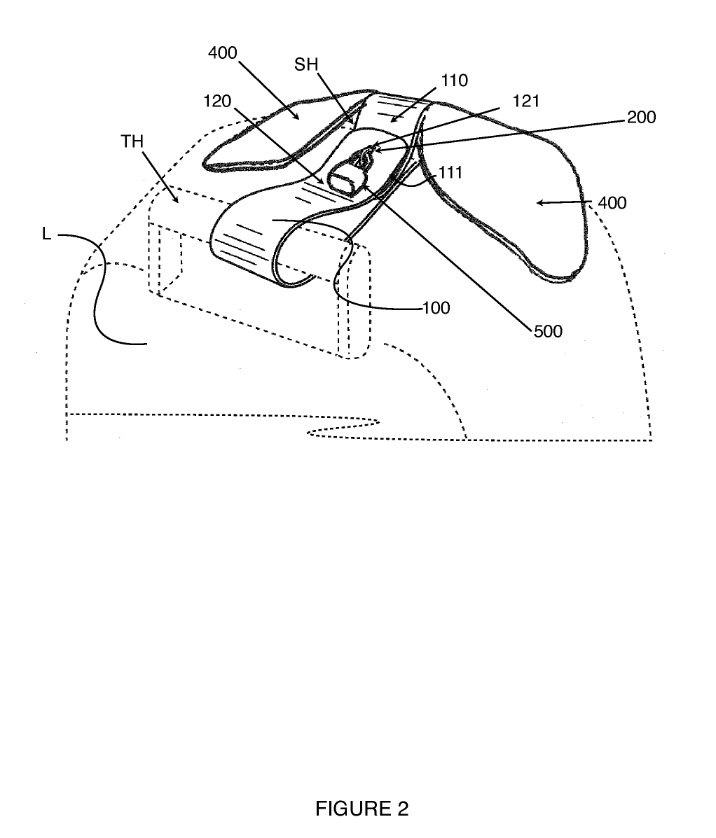

As illustrated in FIG. 2, the first end 110 of the flexible strap 100 is capable of being folded around the stationary handle (SH) of luggage (L) and the first connector 111 removably engaged with the engagement structure 200; likewise, the second end 120 is capable of being folded around the telescopic handle (TH) of the luggage and the second connector 121 removably engaged with the engagement structure 200. Once each of the first connector 111 and second connector 121 is attached and secured to the engagement structure 200, the telescopic handle is no longer capable of being fully extended for rolling the bag.

The engagement structure 200 may be in the form of a loop (as illustrated in FIG. 1) dimensioned for removable engagement by the first connector 111, the second connector 121 and a locking means to lock the first connector 111 and second connector 121 to the engagement structure 200 to prevent the telescopic handle from being extended and utilized to roll the luggage. The locking means may be a locking mechanism built into the engagement structure 200 or a separate locking mechanism/device as will be described further herein.

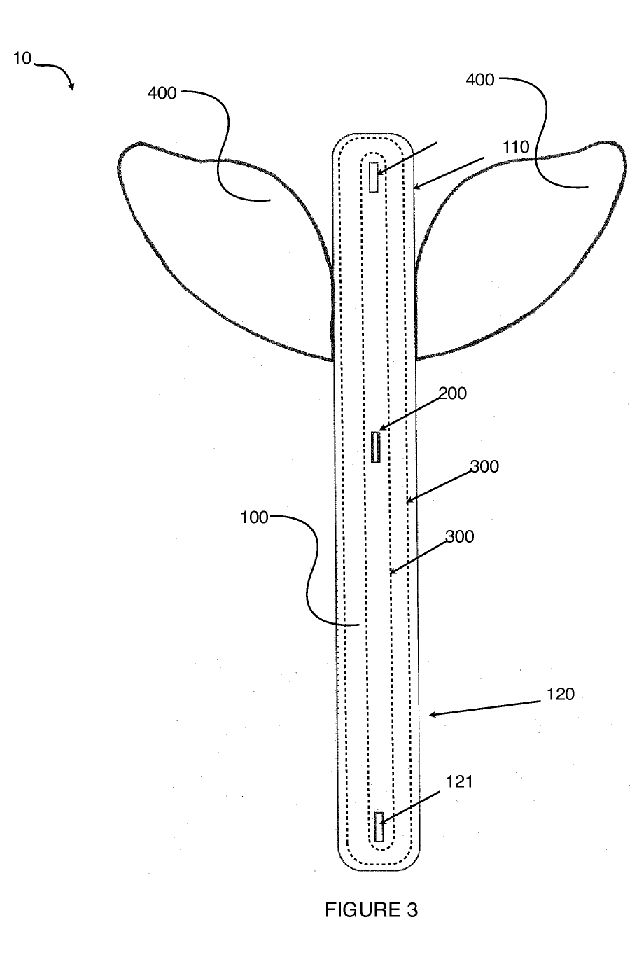

As illustrated in FIG. 3, the flexible strap 100 may additionally include at least one reinforcement strip 300 secured thereto. Typically, the flexible strap 100 is fabricated such that the reinforcement strip(s) is/are an integral component of the strap 100 and may not be visible on the exterior surface of the strap 100. Nevertheless, it is contemplated by the present invention that the reinforcement strip(s) 300 could be fabricated as an external component of the flexible strap 100. The reinforcement strip 300 may be made of any type of tamper-resistant material that maintains flexibility, as would be understood by those skilled in the art. The tamper-resistant material could be any material that is harder to cut than the rest of the strap 100. Non-limiting examples of possible materials include metals, composites, and plastics. Metals may include steel, aluminum, and alloys. Plastics may include polyvinyl chloride. Particularly preferred embodiments of the present invention utilize twisted, multi-fiber, steel wire reinforcement strips such that both strength and flexibility are maximized.

The one or more reinforcement strips 300 may be integrated into the flexible strap 100 in numerous ways. In some embodiments, the reinforcement strips 300 may run from about the first connector 111 to about the second connector 121 and around the engagement structure 200 therebetween. This design ensures that the reinforcement strip(s) provide(s) necessary security and strength at each of the points on the flexible strap 100 that interact when locked into position, inhibiting removal and/or cutting. In additional embodiments, the reinforcement strip(s) 300 may be secured around the outer perimeter of the flexible strap 100. It is also contemplated, as illustrated in FIG. 3, that some embodiments of the present invention may include reinforcement strips 300 around the outer perimeter in addition to from about the first connector 111 to about the second connector 121. Such multi-reinforcement strip designs add additional strength and security to the luggage security apparatus 10. As would be understood by those skilled in the art and further contemplated by the present invention, even more reinforcement strips can be utilized throughout the flexible strap 100 for added strength.

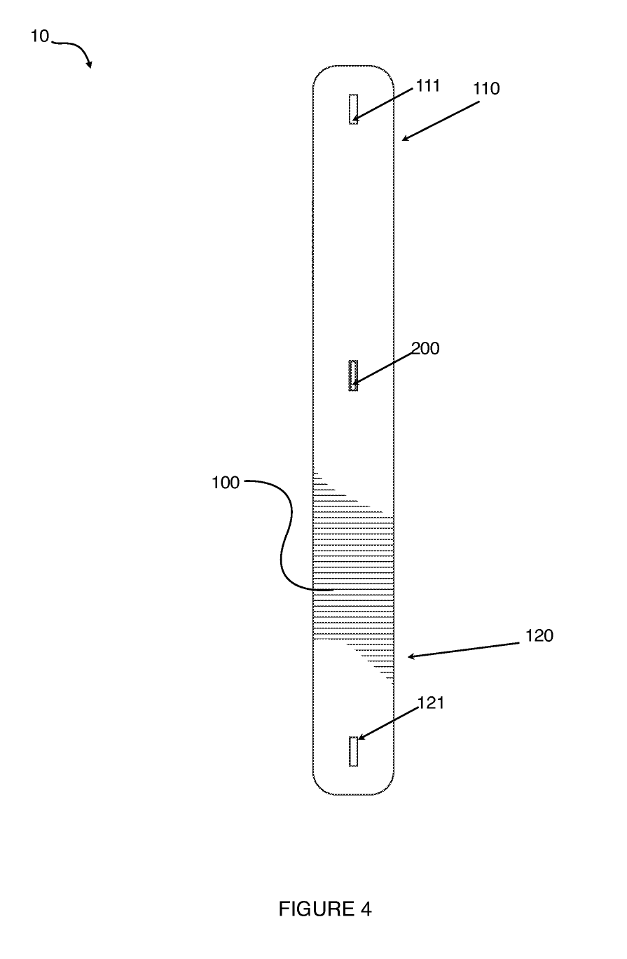

In an additional embodiment of the security apparatus 10, as illustrated in FIG. 4, the apparatus may lack a flexible member extending therefrom. In such embodiments, the functionality remains the same as the other embodiments of the present invention (the telescopic handle is prevented from being extended) except that there is no obstruction of one or more of the handles on the luggage when the apparatus 10 is in place.

Referring again to FIG. 2, an apparatus 10 for preventing extension of the telescopic handle of luggage is shown as utilized on an article of luggage (L). The apparatus 10 utilizes the flexible strap 100 in combination with a locking mechanism 500. The locking mechanism 500 may removably attach and lock to the engagement structure 200, thus also locking the first 110 and second 120 ends of the flexible strap via the first 111 and second 121 connectors in contact with the engagement structure 200. The locking mechanism 500 may include any lockable structure or locking device known in the art. Non-limiting examples include key locks, combination locks, keycard locks, fingerprint locks, radio-frequency identification (RFID) card locks, and combinations thereof.

It is also an object of the present invention that additional security measures may be integrated into the apparatus 10. For instance, security tags may be integrated into the flexible strap 100 such that they are capable of being scanned by a reader before the luggage is taken from a specified area to ensure the person with the luggage is the proper person. Likewise, the security tag may also be designed to incorporate an electronic article surveillance (EAS) tag. The EAS tag must be deactivated by a security agent, or the like, before the apparatus 10 passes through a detection system; otherwise, an alarm will sound. Additional types of future designed security measures that could be incorporated into the apparatus 10 are contemplated, particularly those types of systems that would be utilized in an airport, bus, or train station where passengers generally use luggage.

The present invention is further directed to a method for securing the stationary and telescopic handles of luggage. The method includes placing the luggage security apparatus, as described herein, underneath the stationary and telescoping handles of the luggage; folding the first end around the stationary handle; engaging the first connector with the engagement structure; folding the second end around the telescoping handle; engaging the second connector with the engagement structure; and locking the first and second ends to the flexible strap between the stationary and telescoping handles such that full withdrawal of the telescoping handle is prevented. This may include placing a locking mechanism onto the engagement structure to lock the first connector and second connector to the engagement structure.

Locking the first and second ends to the flexible strap may also include securing the first and second ends to a common engagement point or structure on the flexible strap. This includes placing the first and second connectors, defined in the first and second ends of the flexible strap, respectively, over a loop at the common engagement point or structure. The method may also include securing a locking device through the loop to prevent removal of the first and second ends.

The method may also utilize a built-in locking mechanism that is incorporated into the engagement structure to lock the apparatus instead of placing a separate locking device onto the engagement structure. It would also be understood by those skilled in the art that the first end and second end may engage the telescoping handle and stationary handle, respectively. Furthermore, it would be understood by those skilled in the art that the ordering of folding of the first and second ends is not imperatively done in a certain order and, instead, may be done based on the preference of the user.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A luggage security apparatus, comprising:
a flexible strap comprising a first end, a second end, a first connector and a second connector, wherein the first connector is positioned proximal to the first end and the second connector is positioned proximal to the second end; and
an engagement structure positioned on the flexible strap between the first end and the second end, wherein the first end is capable of being folded around the stationary handle of the luggage and the first connector removably engaged with the engagement structure, wherein the second end is capable of being folded around the telescopic handle of the luggage and the second connector removably engaged with the engagement structure.

2. The luggage security apparatus of claim 1, wherein the engagement structure comprises a loop for removable engagement by the first connector, the second connector and a locking means.

3. The luggage security apparatus of claim 2, wherein the locking means is a locking mechanism built into the engagement structure.

4. The luggage security apparatus of claim 2, wherein the locking means is a locking device for removable attachment to the engagement structure.

5. The luggage security apparatus of claim 1, further comprising at least one reinforcement strip integrally secured to the flexible strap at least from about the first connector to about the second connector.

6. The luggage security apparatus of claim 5, wherein the reinforcement strip is made of a tamper-resistant material.

7. The luggage security apparatus of claim 1, further comprising at least one reinforcement strip integrally secured around an outer perimeter of the flexible strap.

8. The luggage security apparatus of claim 7, wherein the reinforcement strip is made of a tamper-resistant material.

9. The luggage security apparatus of claim 1, further comprising at least one flexible member extending from the flexible strap proximal to the first end for at least partially obstructing the stationary handle.

10. The luggage security apparatus of claim 1, further comprising at least one flexible member extending from the flexible strap proximal to the second end for at least partially obstructing the telescopic handle.

11. The luggage security apparatus of claim 1, further comprising a security tag incorporated into the flexible strap.

12. A luggage security apparatus, comprising:
a flexible strap comprising a first end, a second end, a first connector and a second connector, wherein the first connector is positioned proximal to the first end and the second connector is positioned proximal to the second end;
an engagement structure positioned on the flexible strap between the first end and the second end, wherein the first end is capable of being folded around the stationary handle of the luggage and the first connector removably engaged with the engagement structure, wherein the second end is capable of being folded around the telescoping handle of the luggage and the second connector removably engaged with the engagement structure; and
a locking mechanism, wherein the locking mechanism removably attaches to the engagement structure to lock the first connector and second connector to the engagement structure.

13. The luggage security apparatus of claim 12, wherein the engagement structure comprises a loop-structure dimensioned for removable engagement by the first connector, the second connector and the locking mechanism.

14. The luggage security apparatus of claim 12, further comprising at least one flexible member extending from the flexible strap proximal to the first end for at least partially obstructing the stationary handle.

15. The luggage security apparatus of claim 12, further comprising at least one reinforcement strip integrally secured to the flexible strap at least from about the first connector to about the second connector.

16. The luggage security apparatus of claim 15, wherein the reinforcement strip is made of a tamper-resistant material.

17. The luggage security apparatus of claim 12, further comprising at least one reinforcement strip integrally secured around an outer perimeter of the flexible strap.

18. The luggage security apparatus of claim 17, wherein the reinforcement strip is made of a tamper-resistant material.

19. The luggage security apparatus of claim 12, further comprising a security tag incorporated into the flexible strap.

20. A method of securing the stationary and telescoping handles of luggage, comprising:
routing a flexible strap under the stationary and telescoping handles;
folding first and second ends of the flexible strap over the stationary and telescoping handles, respectively; and
locking the first and second ends to the flexible strap between the stationary and telescoping handles such that full withdrawal of the telescoping handle is prevented.
